(19) United States
(12) Patent Application Publication
(10) Pub. No.: US 2015/0100195 A1
(43) Pub. Date: Apr. 9, 2015

(54) ROUTING EVALUATION EVENTS

(71) Applicant: General Motors LLC, Detroit, MI (US)

(72) Inventors: James J. Kelly, III, Ferndale, MI (US); Jeffrey J. Olsen, Royal Oak, MI (US)

(73) Assignee: General Motors LLC, Detroit, MI (US)

(21) Appl. No.: 14/045,385

(22) Filed: Oct. 3, 2013

(51) Int. Cl. G07C 5/00

(52) U.S. Cl. CPC G07C 5/00
USPC 701/29.1

(57) ABSTRACT

A method of task management for a vehicle telematics unit, including the steps of receiving at a vehicle task manager (VTM) a requested vehicle telematics unit task; receiving at the task manager a first evaluation event for a first condition having a THEN relation with a second condition, the first evaluation event being associated with the requested task; providing the first evaluation event to the first condition; and THEN-blocking any evaluation of second evaluation events for the second condition until the first condition evaluates as TRUE.

### TECHNICAL FIELD

The present invention relates to instruction processing, and more specifically, to evaluating conditions for a telematics unit.

### BACKGROUND

Boolean algebra may be implemented in hardware or software. For example, when implemented in hardware, Boolean algebra may include the use of logic gates such as an AND gate, an OR gate, a NOT gate, etc. In using an AND gate, both inputs to the AND gate must evaluate as TRUE in order for the output to evaluate TRUE. Or in the case of an OR gate, one of the inputs must evaluate as TRUE in order for the output to evaluate TRUE.

These and other logic gates (e.g., NAND, XOR, XNOR, etc.) may be used to determine the various outputs of control systems or schemes based on particular inputs.

### SUMMARY

According to an embodiment of the invention, there is provided a method of task management for a vehicle telematics unit, including the steps of receiving at a vehicle task manager (VTM) a requested vehicle telematics unit task; receiving at the task manager a first evaluation event for a first condition having a THEN relation with a second condition, the first evaluation event being associated with the requested task; providing the first evaluation event to the first condition; and THEN-blocking any evaluation of second evaluation events for the second condition until the first condition evaluates as TRUE.

According to another embodiment of the invention, there is provided a method of managing delivery of diagnostic conditions associated with a vehicle telematics unit, including the steps of: configuring a task manager for monitoring diagnostic data associated with a vehicle telematics unit; monitoring at the task manager at least two conditions associated with a subtask including a first condition and a second condition, the first and second conditions having a THEN relation therebetween, the first condition being on the left-side of the THEN relation, the second condition being on the right-side of the THEN relation, wherein at least one of the first or second conditions is a diagnostic condition; THEN-blocking evaluation of the second condition until the first condition receives a first evaluation event and is determined to be TRUE; and after the first condition is evaluated TRUE, back-blocking evaluation of the first condition until the second condition receives a second evaluation event and has been evaluated at least one time.

According to another embodiment of the invention, there is provided a method of task management for a vehicle telematics unit, including the steps of: receiving at a vehicle task manager (VTM) a requested vehicle telematics unit task; presetting the state of a first condition to FALSE and the state of a second condition to FALSE, wherein the first condition and the second condition have a THEN relation, the first condition being on the left side of the THEN relation, the second condition being on the right side of the THEN relation; receiving one or more evaluation events at the first condition; based on step (c), evaluating the first condition as TRUE or FALSE for each received evaluation event; THEN-blocking any evaluation of the second condition until the first condition evaluates as TRUE; and back-blocking the first condition from re-evaluating any of the one or more evaluation events received at the first condition when the first condition evaluates TRUE until the second condition has evaluated an evaluation event received at the second condition at least once.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2A is a schematic diagram of one implementation of the vehicle telematics unit shown in FIG. 1 and a vehicle task manager;

FIG. 2B is a schematic diagram of another implementation of a vehicle telematics unit shown in FIG. 1 and the vehicle task manager;

FIG. 3 is a flowchart illustrating the hierarchy of a vehicle task;

FIG. 4 is a schematic diagram illustrating one implementation of a vehicle subtask;

FIG. 5 is a schematic diagram illustrating another implementation of a vehicle subtask; and

FIG. 6 is a schematic diagram illustrating an exemplary condition of the vehicle subtask shown in FIG. 4.

### DETAILED DESCRIPTION OF THE ILLUSTRATED EMBODIMENT(S)

The method described below generally pertains to a vehicle task manager (VTM) which may be coupled to or a sub-component of a telematics unit in a vehicle. The VTM executes various tasks according to the completion of subtasks, the satisfaction of variously arranged conditions within the subtasks, priority of actions related to the tasks and subtasks, and according to the VTM's preconfigured capability (e.g., bandwidth, processing capability, etc.). The tasks may be composed of one or more subtasks, and the subtasks may be composed of one or more conditions, actions, and relation functions (RFs). Thus, when all the subtasks are completed for a given task, the task is complete. The condition(s) of a subtask may be evaluated upon the receipt of a corresponding or associated evaluation event; i.e., evaluation events correspond to at least one condition of the task (or subtask). Upon receipt of the evaluation event(s), the condition(s) are evaluated using the RFs or logical operators (e.g., a BOOLEAN relation, an AND relation, an OR relation, a NOT relation, etc.). Provided the condition(s) are TRUE (or as will be explained in greater detail below, provided the combination or clause or expression including multiple conditions is TRUE), an action may be executed or performed. When the action is performed, the subtask may be complete.

In one embodiment, a THEN relation function (RF) may be used. For example, the subtask may be: (condition J THEN condition K)→action A. As will be described in greater detail below, here condition J must be performed before condition K can be evaluated. Thus, evaluation of condition K is blocked until condition J is TRUE. Further, in at least one embodiment, even after condition J evaluates to or becomes TRUE, condition J no longer may be evaluated until an evaluation event triggers the evaluation of condition K at least once. Thus, the condition J is back-blocked (i.e., prohibited from evaluation) until condition K is evaluated at least one time.

The present disclosure illustrates the THEN relation and various implementations of blocking and back-blocking in a telecommunications environment using a communications system; however, it will be apparent that the THEN relation, blocking, and back-blocking may be used in a number of environments and applications. Prior to describing the method, the communication system is set forth below.

### Communications System—

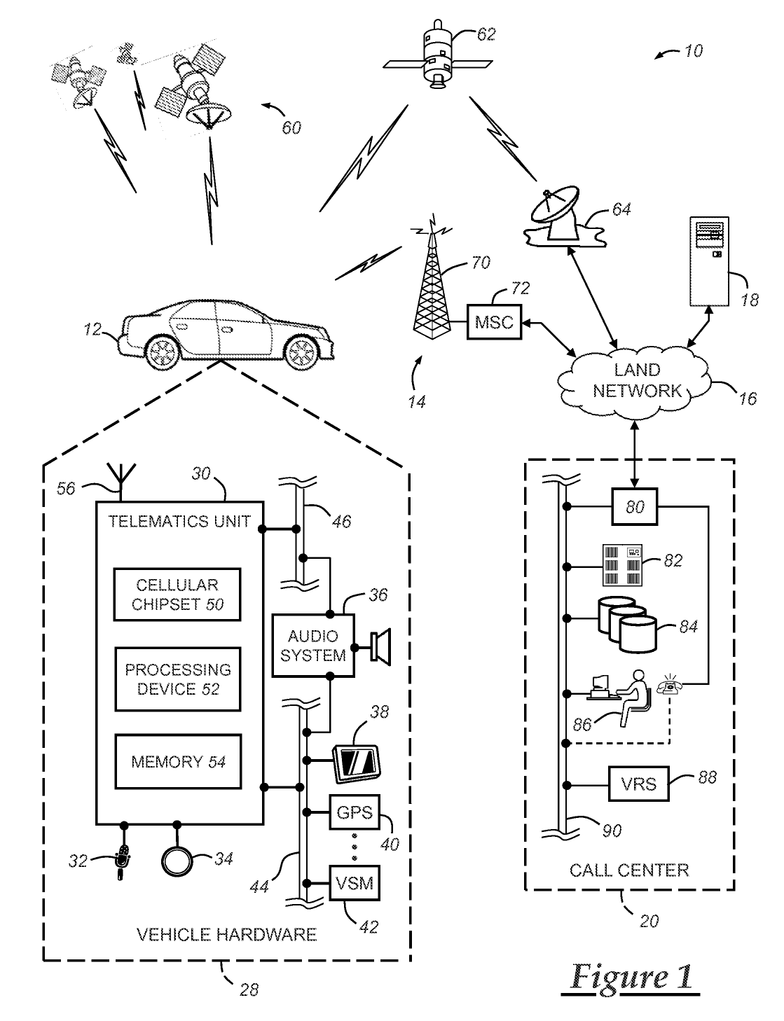

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

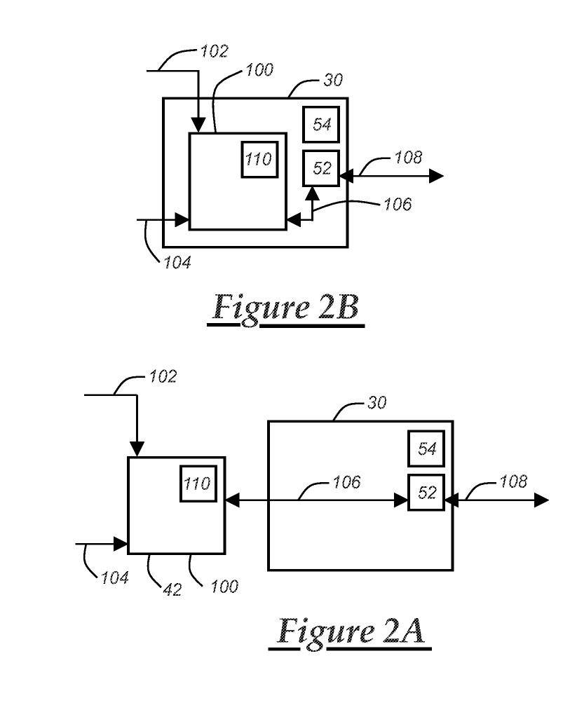

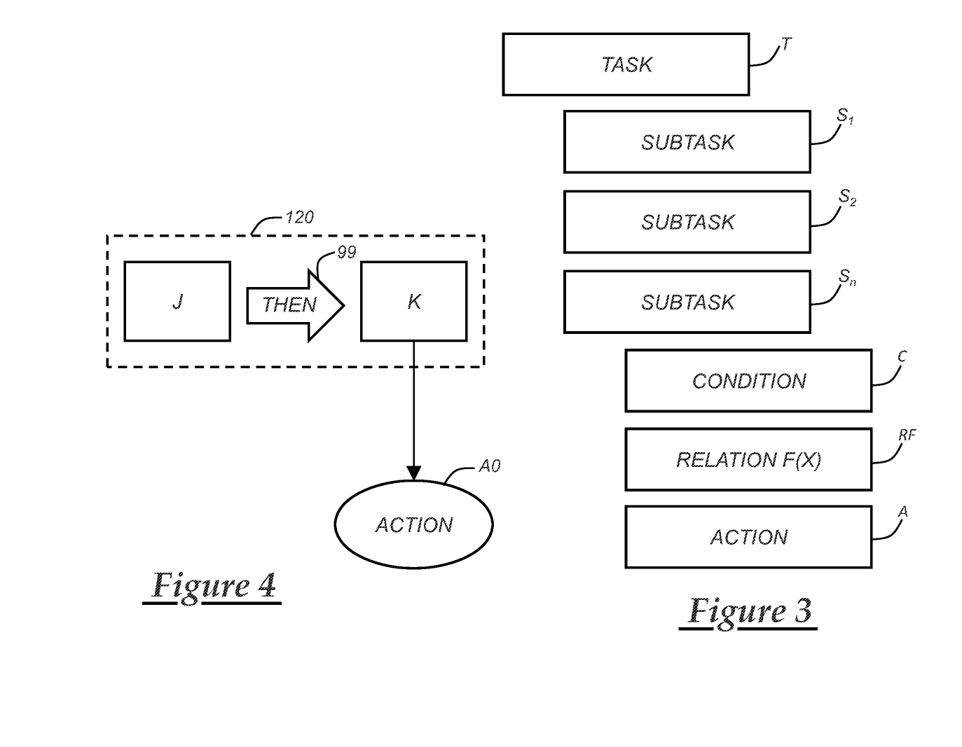

As previously described, a vehicle task manager (VTM) 100 may be coupled to or a sub-component of the telematics unit 30 (see FIGS. 2A, 2B). The VTM may be a configurable monitoring device that receives and prioritizes the various requested tasks 102 demanded of the telematics unit 30. The VTM also may be configured to receive various event data 104; e.g., one or more evaluation events or trigger(s) indicating an event has occurred. Depending on the configuration of the VTM and the received event data, the VTM may determine when to send an instruction 106 to the telematics unit (e.g., the processor 52) to execute the requested task 102. The VTM may make this determination based on the evaluation of one or more subtasks associated with each task. As illustrated in FIG. 3, each subtask (S₁, S₂, . . . , Sₙ) of task T may include at least one condition C, at least one relation function RF, and at least one action A. Thus, the VTM 100 may initiate data storage, cellular communications, and any other suitable task based on one or more predetermined conditions being met following a triggered event.

The VTM 100 may be composed of hardware, software, firmware, or any combination thereof. Hence, as FIG. 2A illustrates the VTM as a VSM 42, the VTM may also be configured as shown in FIG. 2B (e.g., as an embedded component or configuration of the telematics unit (e.g., software on a computer readable medium)). Regardless, of the implementation, the telematics unit 30 also may be configured to receive a requested task 108 and communicate this to the VTM 100 via 106.

In some embodiments, the VTM 100 further may include a storage buffer for storing, at least temporarily, various data associated with executing tasks and subtasks. For example, the storage buffer 110 may have memory to retain the condition(s), action(s), and relation formula for a given subtask, as will be explained in greater detail below.

Returning to FIG. 1, GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

### Method —

As previously described, the vehicle task manager or VTM 100 may process one or more tasks, and each task may include one or more subtasks. As previously discussed, the subtasks may include one or more conditions, a relation, and one or more actions. For example, in some implementations, a condition initially may be preset to a FALSE state. Thereafter, the condition may receive an evaluation event to trigger the evaluation of the condition. Evaluation events may be internally generated (e.g., within the VTM 100) or externally originated (from the vehicle 12 or telematics unit 30). Where the relation evaluates to TRUE, the action may be performed. In some instances, the subtask may contain one or more clauses. For example, a clause may be a single condition or multiple conditions captured within a parenthetical, as will be described in greater detail below.

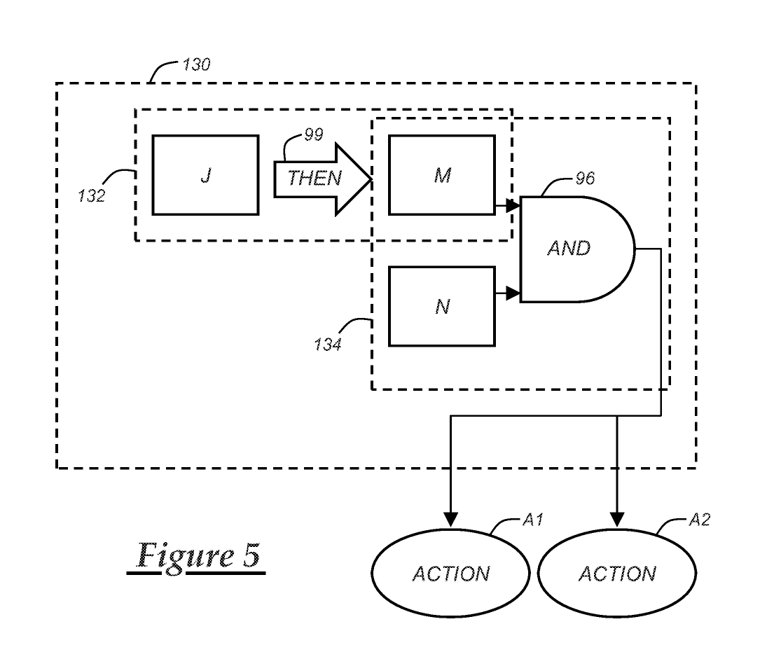

FIG. 4 illustrates two conditions J, K which are preset to a FALSE state, a THEN relation 99, and action A0. Here, when both conditions J and K evaluate to TRUE, action A0 will be performed or executed. In this example, condition J may be evaluated whenever evaluation events are provided to it. However, condition K is THEN-blocked until condition J is evaluated to be TRUE. THEN-blocking includes inhibiting the delivery of evaluation events to condition K, refusing receipt of evaluation events at condition K, simply ignoring received evaluation events at condition K, or not taking the action A0 even if K is evaluated.

Once condition J is evaluated to be TRUE, condition K may be un-THEN-blocked; i.e., condition K may evaluate an evaluation event, if it is received or delivered. Condition K remains un-THEN-blocked until it receives an evaluation event. Upon receipt of this evaluation event, if condition K is evaluated TRUE (i.e., if clause 120 or “(JthenK)” evaluates TRUE), action A0 will be performed. However, action A0 will not be performed if condition K is evaluated FALSE. Once condition K makes its evaluation of an evaluation event as either TRUE or FALSE, both conditions J, K will be reset to FALSE and await further future evaluation events.

When condition K is un-THEN-blocked, condition J may be back-blocked. Being back-blocked, condition J may not evaluate additional evaluation events (or be re-evaluated), that is, until condition K evaluates an evaluation event (of course, the back-blocking of condition J may include inhibiting delivery of evaluation events, refusing receipt thereof, or ignoring received events, etc., as previously described). Thus, both the un-THEN-blocked state of condition K and back-blocked state of condition J continue until condition K evaluates an evaluation event at least once. When this evaluation occurs, condition J will be un-back-blocked.

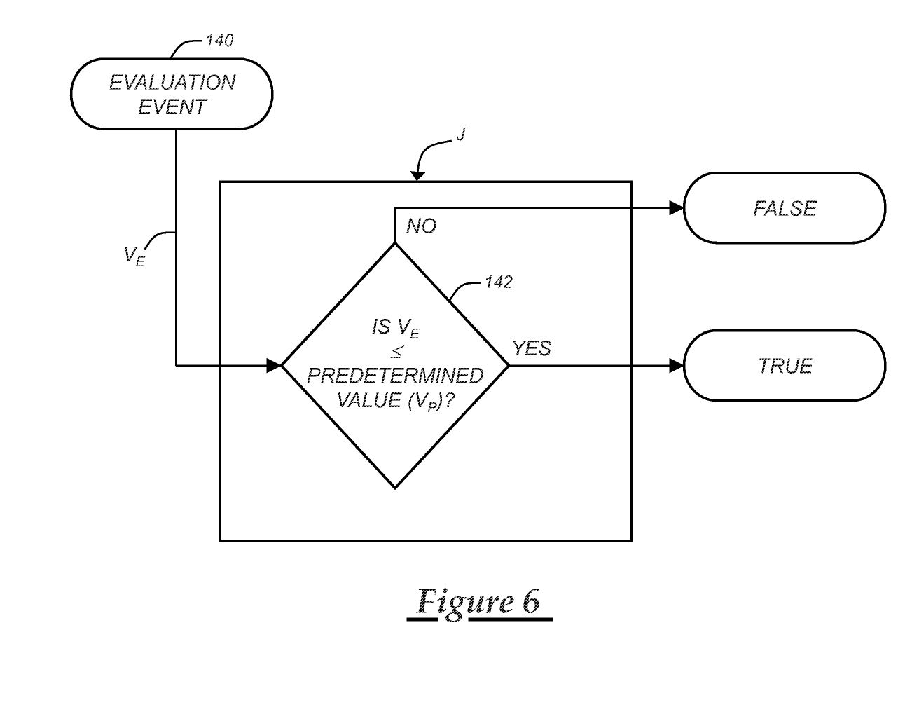

In one implementation, the conditions J and K of FIG. 4 may be a subtask pertaining to engine conditions. For example, condition J may evaluate oil pressure and condition K may evaluate engine temperature. Thus as shown in FIG. 6, either continuously or from time to time, condition J may receive an evaluation event 140 of determining that the engine oil pressure (V_{E}) is low. To illustrate, normal oil pressure may correlate to 5 quarts of oil. Thus, low oil pressure may be correlated a predetermined value (V_{P}) associated with less than 4.5 quarts of oil in the engine. Thus, provided condition J determines that the oil pressure is greater than or equal to 4.5 quarts, the low oil pressure evaluation at condition J will be FALSE. In one embodiment, condition K (of FIG. 4) will not be evaluated while condition J is FALSE (i.e., condition K is THEN-blocked). However, once the oil pressure drops below 4.5 quarts, condition J may be evaluated as TRUE. Thereafter, condition K may be evaluated and condition J will not be evaluated again (or re-evaluated) until condition K is evaluated at least once (i.e., condition J is back-blocked). The evaluation (of condition K) may be similar to that illustrated in FIG. 6 (with respect to condition J). For example, in the instance of condition K, normal engine temperature may be between 180-200° F. Thus, a high engine temperature may be greater than 200° F. It will be appreciated that a vehicle running low on oil (e.g., between 4.5 quarts and 5.0 quarts) may not measurably raise the engine temperature; however, where the oil level is less than 4 quarts, the engine temperature may raise, at least slightly, above 200° F. Thus, when condition K is evaluated, if the engine temperature is less than or equal to 200° F., then condition K may be evaluated to FALSE; and if the engine temperature is greater 200° F., then condition K may be evaluated to TRUE. If condition K is TRUE, then action A0 may be performed. In one example, action A0 may be to send a visible alert to the user of the vehicle 12; or for example, it may send a notification to the call center 20, which may take additional actions to notify the user of the vehicle. If condition K is FALSE, then action A0 is not evaluated. Once condition K has been evaluated at least once, both conditions may be reset to FALSE and await re-evaluation.

Thereafter, it is possible that condition J may either await another evaluation event or may be immediately re-evaluated (e.g., evaluated TRUE again). Thus, re-checking the engine temperature according to the evaluation event associated with condition K. This cyclical process may continuously occur to alert the vehicle user the moment the engine temperature exceeds a predetermined value (e.g., 200° F.). It should be appreciated that this is merely one example of a THEN relation and that the example shown in FIG. 6 is only meant to illustrate one possible evaluation; thus, other arrangements and implementations of THEN relations may be used and the evaluation in FIG. 6 of condition J is merely one example.

The conditions illustrated in FIG. 4 may or may not be latched (or ‘hold’ a given state, e.g., holding TRUE or holding FALSE). For example, in at least some embodiments, conditions (J, K, or both) may have a characteristic known as a latch mode that defines, e.g., how, when, for how long, etc. a condition may be latched. For example, a latched condition may be assumed to be TRUE and hold that state until a predetermined event occurs. Any evaluation events routed to a latched condition may be ignored or discarded. In addition, when the condition becomes unlatched, the state of the condition may be changed to FALSE.

FIG. 5 illustrates a more complex subtask including conditions J, M, N, the THEN relation 99, an AND relation 96, and actions A1 and A2. The entire subtask may be considered a clause 130 (e.g., “(((JthenM)andN)),” where if clause 130 evaluates to TRUE, actions A1 and A2 may be performed. Also, it should be appreciated that the subtask in FIG. 5 may be considered to be multiple clauses; e.g., as previously discussed, each condition may be considered a clause; additionally, conditions (JthenM) may be a clause 132 and (MandN) may be a clause 134.

FIG. 5 further illustrates an operative effect of the THEN clause in a subtask. For example, actions A1 and A2 will never be performed unless clause 132 (JthenM) is TRUE. Thus, actions A1 and A2 will never be performed unless condition M is TRUE. In FIG. 5, conditions J and N (without latching) may evaluate evaluation events as they are received; and condition N may change from TRUE to FALSE, from FALSE to TRUE, etc. as evaluation events are received. Condition J may be continuously evaluated; however, once it evaluates to TRUE, as previously described, condition J will be back-blocked and prevented from re-evaluation until condition M is evaluated once. In addition at this time, condition M will be un-THEN-blocked and may be evaluated one time.

In one subtask implementation, the evaluation of condition J may be initiated by the call center 20. For example, condition J may be TRUE if the telematics unit has received a request pertaining to the fuel economy of the vehicle during the present trip (i.e., since the last vehicle ignition). Thus, condition J may be FALSE if the telematics unit has not received such a request. Also, condition J may repeatedly evaluated FALSE as the VTM continuously checks to determine if condition J is TRUE (i.e., if the call center request has been received). Once the request is received and the condition J is TRUE, it is no longer evaluated until condition M is evaluated one time (condition J is back-blocked). Condition M may be a determination of the trip's fuel economy; e.g., if the fuel economy is less than 30 MPG, condition M may be TRUE (indicating poor fuel economy); otherwise, condition M evaluates FALSE. Condition N may pertain to whether the vehicle owner is present in the vehicle. This may be determined in a variety of ways known to skilled artisans (e.g., whether the owner's mobile device is within the vehicle cabin, e.g., using Bluetooth). Where the owner is in the vehicle 12, condition N may evaluate to TRUE; where he/she is not, condition N may evaluate FALSE. Therefore, according to the AND relation 96, if conditions M and N evaluate TRUE at the same time, actions A1 and A2 may be taken. In one example, action A1 may be a visible and/or audible notification via the vehicle electronics. Action A2 may include reporting to the call center the results of the request. Once M has evaluated once, both conditions J and M may be reset to FALSE; and as previously discussed, condition N may continue to be evaluated TRUE or FALSE.

The previous example may enable the telematics unit, VSMs, and/or other computing resources of the vehicle 12 to operate more efficiently. For example, in the absence of the THEN relation between conditions J and M, both J and M may have to be evaluated immediately (or simultaneously) or not at all. For example, if condition M was not able to be evaluated at the time condition J evaluated TRUE, e.g., due to various computing demands and priorities, the evaluation opportunity at condition M may be missed. In this example, the THEN relation enables condition J to evaluate to TRUE regardless of whether the vehicle is ready or able to determine the fuel economy at that particular moment.

All of the described tasks, subtasks, conditions, etc. may be associated with various vehicle functions performed or requested of the telematics unit 30. For example, a VTM task could be configured to request and store diagnostic information based on receiving a serial data message of a certain format, and initiate a data upload when the data storage buffer is 75% full.

In at least one implementation, the VTM 100 may store information relevant to a condition on the left side of a THEN relation in an action that exists on the right side of the THEN relation using the storage buffer 110 (see FIGS. 2A and 2B). Thus in the example of FIG. 4, the action A0 may store information relevant to condition J (e.g., that the oil pressure is low) while condition J is back-blocked.

Diagnostic related information pertaining to vehicle functions may include monitoring the temperature of vehicle components (e.g., the engine and the transmission via their respective fluids), monitoring the functionality of vehicle components (e.g., sensors in brake pads indicating significant wear), or monitoring other aspects of vehicle operation (e.g., odometer values, oxygen sensor data output, etc.). Other diagnostic related information as well as the generation of DTCs based on that information will be apparent to skilled artisans.

Actions associated with a task (e.g., A0-A2) may be performed or executed as they are received. When two or more actions are available to be performed but they cannot feasibly be performed simultaneously, they may be performed at one time (e.g., according to a priority associated with their identifier(s)). For example, identifiers having a higher identifier value may be performed before identifiers having lower values. Thus if the actions from FIGS. 4-5 were called to be performed all at one time (and could not feasibly accomplished), A0 may be performed last while A2 may be performed first. Of course, this is merely an example and other implementations exist.

Thus, there has been described a vehicle task manager (VTM) for use with a vehicle telematics unit. The VTM may perform tasks, e.g., using subtasks that include condition(s), relation functions), and action(s). At least some of the subtasks may use a THEN relation, e.g., between a first condition and a second condition. The first condition may be evaluated as it receives evaluation events; however, the second condition may be THEN-blocked from receiving its corresponding evaluation events until the first condition is evaluated to be TRUE. When the first condition is TRUE, the second condition may be un-THEN-blocked, and the first condition may be back-blocked from receiving or evaluating any corresponding evaluation events to it while the second condition awaits receipt of an evaluation event. Following the evaluation event at the second condition, if the second condition is TRUE, a corresponding action may be performed. Once the action is performed or queued to perform in a storage buffer, both the first and second conditions may be reset to FALSE. And if the second condition evaluates FALSE, both the first and second conditions may be reset to FALSE, the second condition will again be THEN-blocked, and the first condition will be un-back-blocked.

The THEN-relation may be used in a variety of vehicle applications including conditions associated with diagnostic trouble codes.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of task management for a vehicle telematics unit, comprising the steps of:
(a) receiving at a vehicle task manager (VTM) a requested vehicle telematics unit task;
(b) receiving at the task manager a first evaluation event for a first condition having a THEN relation with a second condition, the first evaluation event being associated with the requested task;
(c) providing the first evaluation event to the first condition; and
(d) THEN-blocking any evaluation of second evaluation events for the second condition until the first condition evaluates as TRUE.

2. The method of claim 1, wherein step (d) further comprises evaluating the first condition to be TRUE based upon the first evaluation event or based upon additionally provided first evaluation events, and un-THEN-blocking the second condition and back-blocking the first condition.

3. The method of claim 2, wherein back-blocking the first condition includes not evaluating any additionally provided first evaluation events at the first condition until the second condition receives a second evaluation event and is evaluated at least once.

4. The method of claim 3, further comprising step (e): evaluating a second evaluation event at the second condition, the second condition being TRUE based on the second evaluation event, and thereafter performing at least one action based on the THEN relation being TRUE.

5. The method of claim 4, further comprising evaluating one or more conditions downstream of the first and second conditions prior to performing the at least one action.

6. The method of claim 4, wherein the at least one action includes one of establishing a cellular connection, establishing a packet data connection, storing data in a storage buffer, or playing an audio file.

7. The method of claim 3, further comprising step (e): evaluating a second evaluation event at the second condition, the second condition being FALSE based on the second evaluation event, and thereafter setting the state of the first and second conditions to FALSE.

8. The method of claim 7, wherein upon evaluating the second condition as FALSE, the first condition is un-back-blocked and the second condition is THEN-blocked again.

9. The method of claim 1, wherein the requested task of step (a) comprises at least one subtask, wherein the at least one subtask includes a first clause having one or more conditions and a second clause having one or more conditions, the first clause having the THEN relation with the second clause, the first condition being one of the one or more conditions of the first clause, the second condition being one of the one or more conditions of the second clause.

10. The method of claim 1, wherein the task includes a plurality of conditions, at least some of the plurality of conditions having one of a plurality of relation functions therebetween, the relation functions including a BOOLEAN relation, an AND relation, an OR relation, a NOT relation, or the THEN relation.

11. The method of claim 1, wherein at least one of the first or the second conditions is associated with a diagnostic trouble code (DTC).

12. A method of managing delivery of diagnostic conditions associated with a vehicle telematics unit, comprising the steps of:
(a) configuring a task manager for monitoring diagnostic data associated with a vehicle telematics unit;
(b) monitoring at the task manager at least two conditions associated with a subtask including a first condition and a second condition, the first and second conditions having a THEN relation therebetween, the first condition being on the left-side of the THEN relation, the second condition being on the right-side of the THEN relation, wherein at least one of the first or second conditions is a diagnostic condition;
(c) THEN-blocking evaluation of the second condition until the first condition receives a first evaluation event and is determined to be TRUE; and
(d) after the first condition is evaluated TRUE, back-blocking evaluation of the first condition until the second condition receives a second evaluation event and has been evaluated at least one time.

13. The method of claim 12, wherein the initial state of the at least two conditions is FALSE.

14. The method of claim 12, wherein all of the at least two conditions are evaluated at the time they receive an evaluation event unless they are THEN-blocked.

15. The method of claim 12, further comprising:
(e) evaluating the second condition at least once, wherein the second condition is evaluated FALSE;
(f) un-back-blocking the first condition;
(g) re-THEN-blocking the second condition; and
(h) resetting the state of the first condition to FALSE.

16. The method of claim 12, further comprising:
(e) evaluating the second condition at least once, wherein the second condition is evaluated TRUE;
(f) executing at least one action associated with the first and second conditions;
(g) resetting the states of the first and second conditions to FALSE;
(h) un-back-blocking the first condition; and
(i) re-THEN-blocking the second condition.

17. The method of claim 16, wherein step (f) further comprises first delaying the execution of the at least one action, wherein the task manager stores the at least one action in a storage buffer until the at least one action can be executed.

18. The method of claim 12, wherein back-blocking the first condition does not include latching the first condition.

19. A method of task management for a vehicle telematics unit, comprising the steps of:
(a) receiving at a vehicle task manager (VTM) a requested vehicle telematics unit task;
(b) presetting the state of a first condition to FALSE and the state of a second condition to FALSE, wherein the first condition and the second condition have a THEN relation, the first condition being on the left side of the THEN relation, the second condition being on the right side of the THEN relation;
(c) receiving one or more evaluation events at the first condition;
(d) based on step (c), evaluating the first condition as TRUE or FALSE for each received evaluation event;
(e) THEN-blocking any evaluation of the second condition until the first condition evaluates as TRUE; and
(f) back-blocking the first condition from re-evaluating any of the one or more evaluation events received at the first condition when the first condition evaluates TRUE until the second condition has evaluated an evaluation event received at the second condition at least once.

20. The method of claim 19, further comprising:
(g) based on step (f), executing an action associated with the first and second conditions when the second condition evaluates TRUE, or not executing the action associated with the first and second conditions when the second condition evaluates FALSE;
(h) when the second condition evaluates FALSE, un-back-blocking the first condition and re-THEN-blocking the second condition until the first condition re-evaluates as TRUE; and
(i) resetting the state of the first condition to FALSE before the first condition evaluates any of the one or more evaluation events received at the first condition.
